(19) United States
(12) Patent Application Publication
(10) Pub. No.: US 2021/0292520 A1
(43) Pub. Date: Sep. 23, 2021

(54) RUBBER MIXTURES

(71) Applicant: Evonik Operations GmbH, Essen (DE)

(72) Inventors: Andre WEHMEIER, Koeln (DE); Caren ROEBEN, Essen (DE); Sascha ERHARDT, Rheinfelden (DE); Julia HERMEKE, Gerlingen (DE); Ralph MOSER, San Diego, CA (US); Elisabeth BAUER, Kleines Wiesental (DE); Sebastian ROSENSTINGL, Loerrach (DE); Stefanie MAYER, Rheinfelden (DE)

(73) Assignee: Evonik Operations GmbH, Essen (DE)

(21) Appl. No.: 17/260,137

(22) PCT Filed: Aug. 6, 2019
(86) PCT No.: PCT/EP2019/071109

§ 371 Date: Jan. 13, 2021

(30) Foreign Application Priority Data
Aug. 16, 2018 (DE) 10 2018 213 774.9

(51) Int. Cl. C08L 9/06; C08K 5/548; C08K 5/5415

(52) U.S. Cl. CPC C08L 9/06; C08K 2201/014; C08K 5/5415; C08K 5/548

(57) ABSTRACT

The invention relates to rubber mixtures which comprise at least one rubber, at least one mercaptosilane of the general formula I R¹₃Si—R²—S—R³ and at least one mixture of polysulfanes of the formula II R¹₃Si—R²SₓR²—SiR¹₃.

The rubber mixture is produced by mixing at least one rubber, at least one mercaptosilane of the general formula I and at least one mixture of polysulfanes of the formula II.

The rubber mixture can be used to produce moulded articles.

The present invention relates to rubber mixtures, to a process for the production thereof and to the use thereof.

EP 1285926, EP 1683801 and EP 1829922 disclose mercaptosilanes or polysulfidic silanes having polyether groups.

Moreover, “Si 266® as processing aid for VP Si 363®” discloses that the addition of Si 266® can improve Mooney viscosity and Mooney scorch characteristics. (http://automotive.evonik.com/product/automotive/en/innovations/fuel-savings-emission-reduction/Pages/si363.aspx).

Disadvantages of the known rubber mixtures comprising the silane mixtures are poorer dynamic properties and lower abrasion resistance.

The problem addressed by the present invention is that of producing rubber mixtures with silane mixtures that have improved dynamic properties and improved abrasion resistance.

The invention provides rubber mixtures which are characterized in that they comprise at least one rubber, at least one mercaptosilane of the general formula I

R¹₃Si—R²—S—R³ I

and at least one mixture of polysulfanes of the formula II

R¹₃Si—R²—Sₓ—R²—SiR¹₃ II

where R¹ is the same or different and is an alkyl polyether group —O—(R⁴—O)ₘ—R⁵, C1-C12-alkyl or R⁶O group, where at least one R¹ group in the mercaptosilane of the general formula I may preferably be an alkyl polyether group —O—(R⁴—O)ₘ—R⁵,

R² is a branched or unbranched, saturated or unsaturated, aliphatic, aromatic or mixed aliphatic/aromatic divalent C1-C30 hydrocarbon group, preferably (CH₂)₃ group, and

R³ is H, CN or (C═O)—R⁷,

where R⁴ is the same or different and is a branched or unbranched aliphatic divalent C1-C30 hydrocarbon group, preferably C2-C3, more preferably CH₂CH₂,

m is 1 to 30, preferably 2-10, more preferably 5,

R⁵ consists of at least 1 carbon atom and is an unsubstituted or substituted, branched or unbranched monovalent alkyl, alkenyl, aryl or aralkyl group, preferably C1-C15-alkyl group, more preferably C7-C15-alkyl group, most preferably C₁₃H₂₇-alkyl group,

R⁶ is H, C1-C30 branched or unbranched monovalent alkyl, preferably methyl, ethyl or propyl, especially preferably ethyl, alkenyl, aryl or aralkyl group,

R⁷ is C1-C30 branched or unbranched monovalent alkyl, preferably methyl, ethyl, propyl, heptyl or octyl, alkenyl, aryl or aralkyl group,

and

x is an integer from 2 to 10, the proportion of polysulfanes in which x=2 reaches a value of at least 90% by weight, preferably 92-98% by weight, more preferably 93-98% by weight, based on the total amount of polysulfanes with x=2 to 10.

The mixture of polysulfanes of the formula II may attain a proportion of the polysulfanes in which x=3 a value of not more than 10% by weight, preferably of not more than 8% by weight, based on the total amount of polysulfanes with x=2 to 10.

The rubber may preferably be a diene rubber.

Silanes of the general formula I may be

(C₁₃H₂₇—(OCH₂CH₂)₅—O—)₃Si—(CH₂)₃—SH,

(C₁₃H₂₇—(OCH₂CH₂)₅—O—)₂(CH₃CH₂O—) Si—(CH₂)₃—SH,

(C₁₃H₂₇—(OCH₂CH₂)₅—O—) (CH₃CH₂O—)₂Si—(CH₂)₃—SH,

(CH₃CH₂O—)₃Si—(CH₂)₃—SH,

(CH₃O—)₃Si—(CH₂)₃—SH or

mixtures of the aforementioned silanes of the general formula I. Mercaptosilanes of the general formula I may also comprise oligomers or polymers of the mercaptosilanes of the general formula I.

Polysulfanes of the general formula II may be:

(CH₃CH₂O)₃Si—(CH₂)₃—Sₓ—(CH₂)₃—Si(OCH₂CH₃)₃ or

(CH₃O)₃Si—(CH₂)₃—Sₓ—(CH₂)₃—Si(OCH₃)₃. Polysulfanes of the general formula II may also comprise oligomers or polymers of the polysulfanes of the general formula II.

In a preferred embodiment, the mercaptosilane of the formula I may be (C₁₃H₂₇—(OCH₂CH₂)₅—O—)₃Si—(CH₂)₃—SH, (C₁₃H₂₇—(OCH₂CH₂)₅—O—)₂ (CH₃CH₂O—) Si—(CH₂)₃—SH, (C₁₃H₂₇—(OCH₂CH₂)₅—O—) (CH₃CH₂O—)₂Si—(CH₂)₃—SH, or mixtures of the aforementioned silanes and the polysulfane of the general formula II (CH₃CH₂O)₃Si—(CH₂)₃—Sₓ—(CH₂)₃—Si(OCH₂CH₃)₃.

The rubber mixture may contain the silane of the general formula I in amounts of 0.1 to 8 parts by weight, based on 100 parts by weight of the rubber used, and the mixture of polysulfanes of the formula II in amounts of 0.1 to 8 parts by weight, based on 100 parts by weight of the rubber used.

The rubber mixture may comprise at least one filler.

Fillers employable for the inventive rubber mixtures include the following fillers:
Carbon blacks: The carbon blacks to be used here may be produced by the lamp black process, furnace black process, gas black process or thermal black process. The carbon blacks may have a BET surface area of 20 to 200 m²/g. The carbon blacks may optionally also be doped, for example with Si.
Amorphous silicas, preferably precipitated silicas or pyrogenic silicas. The amorphous silicas may have a specific surface area of 5 to 1000 m²/g, preferably 20 to 400 m²/g (BET surface area) and a primary particle size of 10 to 400 nm. The silicas may optionally also be in the form of mixed oxides with other metal oxides, such as oxides of Al, Mg, Ca, Ba, Zn and titanium.
Synthetic silicates, such as aluminium silicate or alkaline earth silicates, for example magnesium silicate or calcium silicate. The synthetic silicates having BET surface areas of 20 to 400 m²/g and primary particle diameters of 10 to 400 nm.
Synthetic or natural aluminium oxides and hydroxides.
Natural silicates, such as kaolin and other naturally occurring silicas.
Glass fibres and glass-fibre products (mats, strands) or glass microbeads.

It is possible with preference to use amorphous silicas, more preferably precipitated silicas or silicates, especially preferably precipitated silicas having a BET surface area of 20 to 400 m²/g in amounts of 5 to 180 parts by weight in each case based on 100 parts of rubber.

The rubber mixtures according to the invention may comprise natural rubber and/or synthetic rubbers. Preferred synthetic rubbers are described for example in W. Hofmann, Kautschuktechnologie [Rubber Technology], Genter Verlag, Stuttgart 1980. These include
polybutadiene (BR),
polyisoprene (IR),
styrene/butadiene copolymers, for example emulsion SBR (E-SBR) or solution SBR (S-SBR), preferably having a styrene content of 1% to 60% by weight, more preferably 2% to 50% by weight, based on the overall polymer,
chloroprene (CR),
isobutylene/isoprene copolymers (IIR),
butadiene/acrylonitrile copolymers, preferably having an acrylonitrile content of 5% to 60% by weight, preferably 10% to 50% by weight, based on the overall polymer (NBR),
partly hydrogenated or fully hydrogenated NBR rubber (HNBR),
ethylene/propylene/diene copolymers (EPDM) or
abovementioned rubbers additionally having functional groups, for example carboxyl, silanol or epoxy groups, for example epoxidized NR, carboxyl-functionalized NBR or silanol-functionalized (—SiOH) or siloxy-functionalized (—Si—OR), amino-, epoxy-, mercapto-, hydroxyl-functionalized SBR,

and mixtures of these rubbers. Of particular interest for the production of automobile tyre treads are anionically polymerized S-SBR rubbers (solution SBR) having a glass transition temperature above −50° C. and mixtures thereof with diene rubbers.

Rubber mixtures comprising mercapto-modified S-SBR and polysulfanes of the general formula II can lead to an improvement in processability even without addition of silanes of the general formula I.

The rubber mixtures according to the invention may comprise further rubber auxiliaries, such as reaction accelerators, ageing stabilizers, heat stabilizers, light stabilizers, antiozonants, processing aids, plasticizers, resins, tackifiers, blowing agents, dyes, pigments, waxes, extenders, organic acids, retarders, metal oxides, and activators such as diphenylguanidine, triethanolamine, polyethylene glycol, alkoxy-terminated polyethylene glycol alkyl-O—(CH₂—CH₂—O)_{yl}—H with y^{I}=2-25, preferably y^{I}=2-15, more preferably y^{I}=3-10, most preferably y^{I}=3-6, or hexanetriol, that are familiar to the rubber industry.

The rubber auxiliaries may be used in familiar amounts determined inter alia by factors including the intended use. Customary amounts may, for example, be amounts of 0.1 to 50 parts by weight, based on 100 parts by weight of rubber. Crosslinkers used may be peroxides, sulfur or sulfur donor substances. The rubber mixtures according to the invention may further comprise vulcanization accelerators. Examples of suitable vulcanization accelerators may be mercaptobenzothiazoles, sulfenamides, thiurams, dithiocarbamates, thioureas and thiocarbonates. The vulcanization accelerators and sulfur may be used in amounts of 0.1 to 10 parts by weight, preferably 0.1 to 5 parts by weight, based on 100 parts by weight of rubber.

The present invention further provides a process for producing the rubber mixtures according to the invention which is characterized in that it comprises mixing at least one rubber, at least one mercaptosilane of the general formula I

R¹₃Si—R²—S—R³ I

and at least one mixture of polysulfanes of the formula II

R¹₃Si—R²—Sₓ—R²—SiR¹₃ II

where R¹, R², R³ and x have the definition given above.

The addition of the mercaptosilane of the general formula I and of the mixture of polysulfanes of the formula II, and the addition of the fillers, can be effected at mass temperatures of 100 to 200° C. However said addition can also be effected at lower temperatures of 40° C. to 100° C., for example also, but without restriction, together with further rubber auxiliaries.

The mercaptosilane of the general formula I and the mixture of polysulfanes of the formula II may be added to the rubber mixture individually or in premixed form.

The mercaptosilane of the formula I can be added to the mixing process either in pure form or else having been applied to an inert organic or inorganic carrier or prereacted with an organic or inorganic carrier.

The mixture of polysulfanes of the formula II can be added to the mixing process either in pure form or else having been applied to an inert organic or inorganic carrier or prereacted with an organic or inorganic carrier.

Preferred carrier materials may be precipitated or pyrogenic silicas, waxes, thermoplastics, natural or synthetic silicates, natural or synthetic oxides, preferably aluminium oxide, or carbon blacks. The silanes can also be added to the mixing process having been prereacted with the filler to be used.

The rubber mixtures according to the invention can be vulcanized at temperatures of 100° C. to 200° C., preferably 120° C. to 180° C., optionally under pressure of 10 to 200 bar.

The blending of the rubbers with the filler, any rubber auxiliaries and the silanes can be conducted in customary mixing units, such as rolls, internal mixers and mixing extruders.

The rubber mixtures according to the invention may be used for producing moulded articles, for example for producing pneumatic tyres, tyre treads, cable sheathings, hoses, drive belts, conveyor belts, roller coverings, tyres, shoe soles, sealing rings and damping elements.

The rubber mixtures according to the invention can be produced without addition of guanidines. In a preferred embodiment, the rubber mixture may be free from guanidine derivatives, preferably diphenylguanidine.

The rubber mixtures according to the invention have the advantage that they have better dynamic properties and abrasion resistance.

### EXAMPLES

Determination of the Sulfur Chain Distribution/Length

Analytical separations of the sulfur compounds and the determination of the sulfur chain length were conducted using an analytical HPLC Series 1260 Infinity II system from Agilent Technologies.

Column: Bakerbond C18 (RP), 5 μm, 4.6×250 mm, flow rate 1.50 ml/min, λ=254 nm, column temperature 30° C., mobile phase: mixture of 180 ml of tetrabutylammonium bromide solution (prepared from 400 mg of tetrabutylammonium bromide in 1 I of demineralized water), 450 ml of ethanol and 1370 ml of methanol.

### Example 1: Preparation of bis(triethoxysilylpropyl) disulfide

Sodium carbonate (46.0 g, 1.15 equivalents), sodium hydrogensulfide (30.9 g, 1.04 equivalents, 71%), and demineralized water (170 g) are heated to 72° C. The reaction mixture is stirred at 72° C. for 10 min. Subsequently, sulfur (12.1 g, 1.01 equivalents) is added and the reaction mixture is stirred at 72° C. for 45 min. Tetra-n-butylphosphonium bromide (3.07 g, 0.01 equivalent, 50% in water) and (3-chloropropyl)triethoxysilane (181 g, 2.00 equivalents) are subsequently added successively to the reaction mixture and stirred at 75° C. until conversion is complete. After the reaction has ended, demineralized water is added and a phase separation is conducted. The organic phase is dried over MgSO₄ and the product is isolated as a pale yellow liquid (η=90%).

S2 content: 93.6% by weight, S3 content: 6.1% by weight, S4 content: 0.2% by weight, S5 content: 0.0% by weight, S6 content: 0.0% by weight, S7 content: 0.0% by weight, S8 content: 0.0% by weight, S9 content: 0.0% by weight, S10 content: 0.0% by weight, average sulfur chain length 2.06.

### Example 2: Preparation of bis(triethoxysilylpropyl) disulfide

Sodium (41.0 g, 2.1 equivalents) is added in portions to ethanol (634 g, 16.2 equivalents) at room temperature under a nitrogen atmosphere in a pressure reactor. The reaction mixture is stirred at room temperature for 19 h. Hydrogen sulfide (40.6 g, 1.4 equivalents) is then metered in at a temperature of 45-60° C. and a pressure of 0.5-1.5 bar, and the reaction mixture is stirred for 30 min. Subsequently, sulfur (27.3 g, 1.0 equivalent) is added at 60° C. After stirring at 60° C. for 30 minutes, (3-chloropropyl)triethoxysilane (409 g, 2.0 equivalents) is metered in at a temperature of 60-75° C. and a pressure of 0.5-0.8 bar. The suspension is stirred further at 80° C. and 0.8-2.0 bar until conversion is complete. Thereafter, the reaction mixture is cooled down to room temperature, the suspension is filtered, the filtrate is concentrated under reduced pressure and the product is dried under vacuum. The product is isolated as a pale yellow liquid (η=88%).

S2 content: 93.4% by weight, S3 content: 6.4% by weight, S4 content: 0.2% by weight, S5 content: 0.0% by weight, S6 content: 0.0% by weight, S7 content: 0.0% by weight, S8 content: 0.0% by weight, S9 content: 0.0% by weight, S10 content: 0.0% by weight, average sulfur chain length 2.06.

### Example 3: Rubber Tests

The formulation used for the rubber mixtures is specified in Table 1 below. The unit phr means parts by weight based on 100 parts of the raw rubber used.

TABLE 1

| | Rubber | Rubber | Rubber |
|---|---|---|---|
| | mixture 1 | mixture 2 | mixture 3 |
| Name | (Ref.) | (Ref.) | (Inv.) |
| 1st stage | phr | phr | phr |
| Buna VSL 4526-2 | 96.25 | 96.25 | 96.25 |
| Buna CB 24 | 30.00 | 30.00 | 30.00 |
| ULTRASIL ® 7000 GR | 80.00 | 80.00 | 80.00 |
| Si 363 ™ | 9.00 | 6.90 | 6.90 |
| Si 266 ® | — | 2.80 | — |
| Example 1 | — | — | 2.80 |
| CORAX ® N330 | 5.00 | 5.00 | 5.00 |
| ZnO RS RAL 844 C | 2.00 | 2.00 | 2.00 |
| Edenor ST1 GS | 2.00 | 2.00 | 2.00 |
| Vivatec 500 | 8.75 | 8.75 | 8.75 |
| Vulkanox ® HS/LG | 1.50 | 1.50 | 1.50 |
| Vulkanox ® 4020/LG | 2.00 | 2.00 | 2.00 |
| Protektor G 3108 | 2.00 | 2.00 | 2.00 |
| 2nd stage | | | |
| 1st stage batch | | | |
| 3rd stage | | | |
| 2nd stage batch | | | |
| Richon TBZTD-OP | 0.40 | 0.40 | 0.40 |
| Vulkacit CZ/EG-C | 1.60 | 1.60 | 1.60 |
| 80/90 sulfur | 2.00 | 2.00 | 2.00 |

Substances Used:

a) Buna VSL 4526-2: Buna® VSL 4526-2 HM is a solution styrene-butadiene rubber which is extended with 37.5 phr
TDAE oil; Mooney (1+4 @ 100° C.): 62 MU; vinyl: 44.5%; styrene: 26%, from ARLANXEO Deutschland GmbH

b) Buna CB 24: Buna CB 24 (cis-1,4>96%); neodymium-catalysed butadiene rubber; Mooney (1+4 @ 100° C.): 44 MU, from ARLANXEO Deutschland GmbH

c) Silica: ULTRASIL® 7000 GR from Evonik Resource Efficiency GmbH (readily dispersible precipitated silica, BET surface area=170 m²/g, CTAB surface area=160 m2/g).

d) Si 266®: bis(triethoxysilylpropyl) disulfide from Evonik Resource Efficiency GmbH S2 content: 84.5% by weight, S3 content: 14.4% by weight, S4 content: 1.1% by weight, S5 content: 0.1% by weight, S6 content: 0.0% by weight, S7 content: 0.0% by weight, S8 content: 0.0% by weight, S9 content: 0.0% by weight, S10 content: 0.0% by weight, average sulfur chain length 2.16.

e) 4-((3,6,9,12,15-Pentaoxaoctacosyl)oxy)-4-ethoxy-5,8,11,14,17,20-hexaoxa-4-silatritriacontane-1-thiol, for example Si 363™: mercaptosilane from Evonik Resource Efficiency GmbH.

f) Corax® N 330: carbon black from Orion Engineered Carbons GmbH.

g) ZnO: RS RAL 844 C ZnO zinc oxide from Arnsperger Chemikalien GmbH.

h) EDENOR ST1 GS, stearic acid from Caldic Deutschland GmbH.

i) Vivatec 500: TDAE from H&R GmbH Co. KGaA.

j) Vulkanox® 4020/LG: N-(1,3-dimethylbutyl)-N′-phenyl-p-phenylenediamine (6PPD) from LANXESS Deutschland GmbH.

k) Vulkanox® HS/LG: polymeric 2,2,4-trimethyl-1,2-dihydroquinoline (TMQ) from LANXESS Deutschland GmbH.

l) Protektor G 3109: wax from Paramelt B.V., the Netherlands.

m) Richon TBZTD-OP: tetrabenzylthiuram disulfide (TBzTD) from Weber & Schaer GmbH & Co. KG (manufacturer: Dalian Richon).

n) Vulkacit® CZ/EG-C: N-cyclohexyl-2-benzothiazolesulfenamide from LANXESS Deutschland GmbH.

o) 80/90 sulfur: 80/90° ground sulfur from Azelis Deutschland GmbH.

The mixtures are produced in three stages in a 1.5 l internal mixer by the mixing method described in Table 2.

TABLE 2

| Stage 1 | |
|---|---|
| Settings | |
| Mixing unit | HF Mixing Group GmbH; model: GK 1.5 N |
| Fill level | 0.73 |
| Speed | 70 min⁻¹ |
| Ram pressure | 5.5 bar |
| Flow temp. | 70° C. |
| Mixing | |
| procedure | |
| 0 to 0.5 min | Rubbers |
| 0.5 to 1.0 min | Vulkanox ® HS; Vulkanox ® 4020 |
| 1.0 to 2.0 min | ½ silica, Si 363 ™ |
| 2.0 min | Purge |
| 2.0 to 3.0 | a) CORAX ® N330, TDAE |
| min | b) ½ silica, Si 266 ® or Example 1 |
| | c) Protektor G 3108 |
| 3.0 to 5.0 | ZnO, stearic acid: mix at 150° C., optionally |
| min | adjusting temperature by varying speed |
| 5.0 min | Eject batch and check weight |
| | forma sheet on laboratory mixing roll mill |
| | for 45 s |
| | (laboratory roll mill: diameter 250 mm, |
| | length 190 mm, roll nip 4 |
| | mm, flow temperature 60° C.) |
| | Storage at room temperature for 24 h |
| Stage 2 | |
| Settings | |
| Mixing unit | as in stage 1 except |
| Fill level | 0.70 |
| Flow temp. | 80° C. |
| Mixing | Batch temperature 145-155° C. |
| procedure | |
| 0 to 1.0 min | Break up stage 1 batch |
| 1.0 to 3.0 | DPG; mix at 150° C., optionally adjusting |
| min | temperature by varying speed |
| 3.0 min | Discharge batch and form a milled sheet on |
| | laboratory mixing roll mill for 45 s |
| | (laboratory roll mill: diameter 250 mm, |
| | length 190 mm, roll nip 4 |
| | mm, flow temperature 60° C.) |
| | Storage at room temperature for 24 h |
| Stage 3 | |
| Settings | |
| Mixing unit | as in stage 1 except |
| Fill level | 0.68 |
| Speed | 55 min⁻¹ |
| Flow temp. | 50° C. |
| Mixing | Batch temperature <110° C. |
| procedure | |
| 0 to 2.0 min | Break up stage 2 batch, accelerator and sulfur |
| 2.0 min | Eject batch and, on a laboratory mixing roll mill |
| | form a sheet with roll nip 3-4 mm for 20 s, |
| | make incisions 3x from the left, 3x from the right |
| | with roll nip 3 mm, 3x through roll nip 3 mm, |
| | storage at room temperature for 12-24 h |
| | (laboratory roll mill: diameter 250 mm, length |
| | 190 mm, flow temperature 80° C.) |

Vulcanization is effected at a temperature of 165° C. in a typical vulcanizing press with a holding pressure of 120 bar. The necessary vulcanization time is determined beforehand by means of a moving die rheometer (rotorless vulcameter) as per ISO 6502 (section 3.2 “rotorless curemeter”) at 165° C. (see Table 4).

Rubber testing is effected in accordance with the test methods specified in Table 3.

TABLE 3

| | Raw | | | | |
|---|---|---|---|---|---|
| | mixture | | | | |
| | (R) | | | | |
| | Vulcanizate | Physical | | | |
| Test/method | (V) | parameter | Test conditions | | Standard |
| Mooney | R | ML 1 + 4 / MU | at 100° C. | | DIN 53523/3, |
| viscosity | | | | | ISO 667 |
| Scorch | R | Scorch time | at 130° C. | | DIN 53523/4, |
| characteristics | | t₅/min | | | ISO 667 |
| Scorch | R | Scorch time | at 130° C. | | DIN 53523/4, |
| characteristics | | t₃₅/min | | | ISO 667 |
| Vulcameter test; | R | t 10% / min | at 165° C.; 0.5° | | DIN 53529/3, |
| MDR rheometer | | | | | ISO 6502 |
| Vulcameter test; | R | t 20% / min | at 165° C.; 0.5° | | DIN 53529/3, |
| MDR rheometer | | | | | ISO 6502 |
| Vulcameter test; | R | t 90% / min | at 165° C.; 0.5° | | DIN 53529/3, |
| MDR rheometer | | | | | ISO 6502 |
| Vulcameter test; | R | (t 80%-t 20%)/ | at 165° C.; 0.5° | | |
| MDR rheometer | | min | | | |
| Tensile test | V | 300% stress | at 23° C.: S1 specimen | | ISO 37 |
| | | value / MPa | | | |
| Shore A | V | | at 23° C. | | ISO 7619-1 |
| hardness | | | | | |
| Ball rebound | V | Resilience / % | Fall height 500 mm, steel | | DIN EN ISO |
| | | | ball with d = 19 mm, 28 g | | 8307 |
| Viscoelastic | V | | at 60° C. | | |
| properties | | | “Operators Manual RPA | | |
| | | | 2000” from Alpha | | |
| | | | Technologies, February | | |
| | | | 1997 | | |
| Viscoelastic | V | Complex | 16 Hz, initial force 50 N | | ISO 4664-1 |
| properties | | modulus | and amplitude force 25 N, | | |
| | | E* / MPa | heat treatment time 5 min, | | |
| | | | parameters recorded after | | |
| | | | 30 s testing time | | |
| | V | Loss factor | | | ISO 4664-1 |
| | | tan δ/— | | | |
| Abrasion | V | For each mixture | The following settings were | | ISO 23 233 |
| resistance | | and test condition: | chosen for testing: | | |
| | | Averaged loss of | | Rotational | |
| | | mass/ distance, | Slip angle | speed | |
| | | For each mixture: | degrees | km/h | |
| | | averaged | 16 | 25 | |
| | | percentage | 16 | 12 | |
| | | abrasion | 13 | 2.5 | |
| | | resistance index, | 9 | 25 | |
| | | percentage | 9 | 12 | |
| | | abrasion | 9 | 2.5 | |
| | | resistance index | 5.5 | 25 | |
| | | for low severity | 5.5 | 12 | |
| | | and high severity | 5.5 | 2.5 | |
| | | | 5.5 | 2.5 | |
| | | | 5.5 | 12 | |
| | | | 5.5 | 25 | |
| | | | 9 | 2.5 | |
| | | | 9 | 12 | |
| | | | 9 | 25 | |
| | | | 13 | 2.5 | |
| | | | 16 | 12 | |
| | | | 16 | 25 | |
| LAT wet slip | V | For each mixture | | Rotational | |
| characteristics | | and test condition: | Slip angle | speed | |
| | | averaged lateral | degrees | km/h | |
| | | force coefficient | 15 | 1.5 | |
| | | For each mixture: | 15 | 1.5 | |
| | | percentage wet | 15 | 1.5 | |
| | | slip index for | 15 | 1.5 | |
| | | different test | 15 | 1.5 | |
| | | conditions taking | 15 | 1.5 | |
| | | account of TG by | 15 | 1.5 | |
| | | WLF | | | |

Table 4 reports the rubber data for the crude mixtures and vulcanizates.

TABLE 4

| | | Rubber | Rubber | Inventive |
|---|---|---|---|---|
| | | mixture | mixture | rubber |
| | Unit | 1 (Ref.) | 2 (Ref.) | mixture 3 |
| ML(1 + 4) at 100° C.; after | MU | Too high = | 142 | 144 |
| the 1st mixing stage | | outside the | | |
| | | measurement | | |
| | | range | | |
| ML(1 + 4) at 100° C.; | MU | 104 | 89 | 92 |
| after the 2nd mixing stage | | | | |
| ML(1 + 4) at 100° C.; | MU | 63 | 59 | 60 |
| after the 3rd mixing stage | | | | |
| Mooney Scorch t5 @ 130° C. | min | 12.3 | 27.0 | 24.6 |
| Mooney Scorch | min | 15.0 | 31.6 | 28.8 |
| t35 @ 130° C. | | | | |
| MDR: 165° C.; 0.5° | | | | |
| t 10% | min | 1.1 | 1.5 | 1.8 |
| t 20% | min | 1.5 | 2.5 | 2.4 |
| t 90% | min | 3.7 | 5.8 | 5.7 |
| t 80%-t 20% | min | 1.5 | 2.1 | 2.0 |
| Vulcanization time (165° C.) | min | 8 | 12 | 12 |
| Tensile strength (6 S1 | MPa | 13.6 | 15.0 | 15.7 |
| bars, 23° C.) | | | | |
| 300% modulus | MPa | 9.8 | 9.7 | 10.6 |
| 300%/100% modulus | — | 5.4 | 5.4 | 5.6 |
| Ball rebound, 60° C. | % | 70.4 | 66.7 | 69.4 |
| Zwick, 16 Hz, 50 N +/− 25 N | | | | |
| tan δ, 60° C. | — | 0.088 | 0.095 | 0.089 |
| RPA: 2nd strain sweep | | | | |
| vulcanizate 1.6 Hz, | | | | |
| 60° C., 0.28%-100% | | | | |
| tan δ (max) | — | 0.120 | 0.141 | 0.125 |
| LAT abrasionresistance | % | 100 | 99 | 104 |
| rating | | | | |
| LAT wet slip rating @ 2° C. | % | 100 | 102 | 102 |
| LAT wet slip rating @ 10° C. | % | 100 | 102 | 102 |
| LAT wet slip rating @ 18° C. | % | 100 | 102 | 102 |

It is known that a disulfide silane such as Si 266® can improve the processability of the mercaptosilane Si 363™.

This is shown by the comparison of the Si 266®-containing rubber mixture 2 with the Si 363™-containing rubber mixture 1 by lowered Mooney viscosities in mixing stages 1-3. Mooney scorch values can advantageously also be extended, which is confirmed by the extended t 10% time in the MDR.

These advantages can also be achieved in the case of use of the mixture of polysulfanes of the formula (II) in which x=2 has a value of at least 90% by weight (inventive rubber mixture 3). In this mixture, the t 10% time is surprisingly actually extended again.

While rubber mixture 2 has an equivalent strengthening index (300% stress value/100% stress value) compared to rubber mixture 1, this ratio is improved for the rubber mixture according to the invention. Ultimate tensile strength can also be increased once again compared to rubber mixture 2.

While the advantages in processability in the case of rubber mixture 2 are associated with penalties in hysteresis losses under dynamic stress, these properties in inventive rubber mixture 3 are brought back nearly to the level of rubber mixture 1 in three independent dynamic tests using different stress modes (ball rebound (energy-controlled measurement), Zwick (force-controlled measurement) and RPA (distance-controlled measurement)). This allows distinct lowering of the rolling resistance and hence the fuel consumption of a motor vehicle fitted with tyres that use the rubber mixture according to the invention as tyre tread compound.

Surprisingly, as well as the improvement in wet slip resistance already achieved with rubber mixture 2 compared to rubber mixture I, a distinct improvement in abrasion resistance on the LAT laboratory abrasion tester (Grosch system) was also found.

It is thus possible, with the rubber mixture according to the invention, to achieve a distinct increase in overall performance compared to the two reference mixtures in terms of processing and in terms of the most important rubber properties.

1. Rubber mixtures, characterized in that they comprise at least one rubber, at least one mercaptosilane of the general formula I
R¹₃Si—R²—S—R³ I
and at least one mixture of polysulfanes of the formula II
R¹₃Si—R²—Sₓ—R²—SiR¹₃ II
where R¹ are the same or different and are an alkyl polyether group —O—(R⁴—O)ₘ—R⁵, C1-C12-alkyl- or R⁶O— group,
R² are the same or different and are a branched or unbranched, saturated or unsaturated, aliphatic, aromatic or mixed aliphatic/aromatic divalent C1-C30 hydrocarbon group,
R³ is H, CN or (C═O)—R⁷,
R⁴ are the same or different and are a branched or unbranched aliphatic divalent C1-C30 hydrocarbon group,
m is 1 to 30,
R⁵ consists of at least 1 carbon atom and is an unsubstituted or substituted, branched or unbranched monovalent alkyl, alkenyl, aryl or aralkyl group,
R⁶ is H, C1-C30 branched or unbranched monovalent alkyl, alkenyl, aryl or aralkyl group,
R⁷ is C1-C30 branched or unbranched monovalent alkyl, alkenyl, aryl or aralkyl group,
and
x is an integer from 2 to 10, the proportion of polysulfanes in which x=2 reaches a value of at least 90% by weight, based on the total amount of polysulfanes with x=2 to 10.

2. Rubber mixtures according to claim 1, characterized in that R¹ are the same or different and are methoxy groups, ethoxy groups or alkyl polyether groups —O—(R⁴—O)ₘ—R⁵ and at least one R¹ group in the mercaptosilane of the general formula I is an alkyl polyether group —O—(R⁴—O)ₘ—R⁵, R² are CH₂CH₂CH₂, R³ is H.

3. Rubber mixtures according to claim 2, characterized in that R¹ are the same or different and are ethoxy groups or alkyl polyether groups —O—(R⁴—O)ₘ—R⁵ and at least one R¹ group in the mercaptosilane of the general formula I is an alkyl polyether group —O—(R⁴—O)ₘ—R⁵ and the R¹ groups of the polysulfane of the general formula II are ethoxy groups.

4. Rubber mixtures according to claim 1, characterized in that the mercaptosilane of the general formula I is (C₁₃H₂₇—(OCH₂CH₂)₅—O—)₃Si—(CH₂)₃—SH, (C₁₃H₂₇—(OCH₂CH₂)₅—O—)₂(CH₃CH₂O—)Si—(CH₂)₃—SH, (C₁₃H₂₇—(OCH₂CH₂)₅—O—)(CH₃CH₂O—)₂Si—(CH₂)₃—SH or (CH₃CH₂O—)₃Si—(CH₂)₃—SH.

5. Rubber mixtures according to claim 1, characterized in that the polysulfane of the general formula II is (CH₃CH₂O)₃Si—(CH₂)₃—Sₓ—(CH₂)₃—Si(OCH₂CH₃)₃.

6. Rubber mixtures according to claim 1, characterized in that they comprise filler and optionally further rubber auxiliaries.

7. Rubber mixtures according to claim 1, characterized in that the mercaptosilane of the general formula I is present in amounts of 0.1 to 8 parts by weight, based on 100 parts by weight of the rubber used, and the mixture of polysulfanes of the formula II in amounts of 0.1 to 8 parts by weight, based on 100 parts by weight of the rubber used.

8. Process for producing the rubber mixtures according to claim 1, characterized in that at least one rubber, at least one mercaptosilane of the general formula I and at least one mixture of polysulfanes of the formula II are mixed.

9. Use of rubber mixtures according to claim 1 for producing moulded articles.

10. Use of rubber mixtures according to claim 1 for producing pneumatic tyres, tyre treads, rubber-containing tyre components, cable sheaths, hoses, drive belts, conveyor belts, roll coverings, tyres, footwear soles, gasket rings and damping elements.
